(19) United States
(12) Patent Application Publication
(10) Pub. No.: US 2006/0161405 A1
(43) Pub. Date: Jul. 20, 2006

(54) Methods for locating targets and simmulating mine detection via a cognitive, swarm intelligence-based approach

(76) Inventor: Vignesh Kumar Munirajan, Herndon, VA (US)

Correspondence Address: MARTIN & HENSON, P.C., 9250 W 5TH AVENUE, SUITE 200, LAKEWOOD, CO, 80226, US

(21) Appl. No.: 10/862,059

(22) Filed: Jun. 4, 2004

(51) Int. Cl. G06G 7/48

(52) U.S. Cl. 703/6

(57) ABSTRACT

A method is provided for locating targets dispersed within a target field, whereby a plurality of like robotic scouts are provided for transmitting and receiving target detection signals, and for following a received signal's intensity gradient. The target field is foraged by the scouts according to a navigation scheme which entails stochastically navigating the terrain prior to receipt of a target detection signal, and deterministically navigating the terrain following receipt of the target detection signal, whereby an intensity gradient is followed until the selected target is located. Once located, a scout remains at the selected target until either a selected time duration elapses or a requisite number of other scouts arrive. A method is also provided for emulating detection and diffusion of mines within a mine field, with the same being simulated on a computer system's display device.

### REFERENCE TO COMPUTER PROGRAM LISTING APPENDIX

Reference is made to the single compact disc which is submitted herewith and which forms a part of the specification of this application. The submitted 700 MB compact disc was created on Jun. 4, 2004. The material on the submitted compact disc is incorporated by reference. This material is identified by the file names “Keil 1”, “Keil 2”, “Keil 3”, “Keil 4” and “Matlab”, which have file sizes of 2 KB, 4 KB, 1 KB, 1 KB & 11 KB, respectively.

### BACKGROUND OF THE INVENTION

The present invention generally relates to the field of target location, and is more particularly concerned methodologies for simulating mine detection via swarm-based intelligence techniques.

Intelligence of an entity or a group of entities can be defined in a variety of ways. With regard to the natural sciences, intelligence has been defined as the processing of sensory information or knowledge base optimizing any cost function that would be beneficial to the entity in the long run or towards a global goal. Animals, humans and robots can be analyzed as multi-tasking, autonomous control systems based on well-established ethological principles that exhibit intelligence. Biological systems are argued to exhibit a better understanding of intelligence than that of traditional ‘artificial intelligence’.

Applications to biological based systems are constantly expanding. On of the interesting aspects of biological based studies is swarm intelligence. Swarm intelligence refers to the studies wherein intelligence is bestowed in a disembodied medium. Examples of swarms include ant colonies, wasps, birds, cattle herds, frogs and other colony based living organisms. Swarm Intelligence can be described as the property by which a group of simple, autonomous (i.e. no centralized control), intelligent agents interact indirectly and collectively to bring about solutions to complex tasks. The agents within the colony need not have similar behavior, but can be classified into sub-groups each having similar agents performing similar tasks. The tasks are usually distributive in nature. Basically, swarms exhibit models of behavior-based systems which are autonomous and have a strong desire for reaction and adaptability. Robustness in problem solving is achieved with simple individuals interacting in a dynamic environment producing complex tasks.

Intelligent agents are integrated systems that incorporate major capabilities drawn from several research areas—artificial intelligence, databases, programming languages, and theory of computing. Distributed artificial intelligence (DAI) systems can be described as heterogeneous, autonomous and cooperative systems in which agents act together to solve a given problem. A new trend in distributed artificial intelligence (DAI) considers agents as intelligent units of design that may be customized and composed with other similar units to build complex systems. In artificial intelligence research, agent-based systems technology has been hailed as a new paradigm for conceptualizing, designing, and implementing non-linear and complex systems. Agents have an internal state which reflects their knowledge, and this knowledge may be based on default assumptions, or partially specified and refined during an agent's lifetime.

Multi-agent systems model problems in terms of their autonomous interacting component-agents, which are proving to be a more natural way of representing task allocation, team planning, user preferences, open environments, and so on. Such systems efficiently retrieve, filter, and globally coordinate information from sources that are spatially distributed. They can also enhance overall system performance, specifically in the areas of computational efficiency, reliability, extensibility, robustness, maintainability, responsiveness, flexibility, and reuse. Interactions among agents are established dynamically according to the dependencies among their capabilities. A single function may be provided by different agents and a single agent may provide several functions. Agents can cooperate since they share the same communication language and a common vocabulary which contains words appropriate to common application areas and whose meaning is defined in a shared ontology.

Multi-agent-based systems composed of simple agents that demonstrate complex collective behavior offer several advantages over the complex agents associated with traditional artificial intelligence (AI) systems. Complex agents may fail, and if a central controller is involved in directing actions of such agents, it needs to recover in the event of agent failure. Systems in which agents change their strategies in response to actions by other agents can quickly adapt to environmental changes; however, this feature is usually achieved at the expense of global stability. The high communication and computational cost required to coordinate agent behavior can constrain the size of the traditional AI to, at most, a few dozen agents. Yet another disadvantage is that the complexity of the agent's internal states and its interactions with other agents make these systems ill suited for rigorous quantitative analysis.

Unlike a centralized system which may be plagued by resource limitations, performance bottlenecks, or critical failures, a decentralized, multi-agent system does not suffer from the ‘single point of failure’ problem. Rather, a well-designed multi-agent system can be efficient, robust, adaptive and stable. Because it lacks central control, such a system can recover more quickly from mistakes, agent failure and environmental change. Because it has very low communication and computational requirements, there are virtually no constraints on system size. These simplicities make multi-agent systems amenable to mathematical analysis.

Despite their numerous advantages, however, there have been relatively few implementations of multi-agent system outside of distributed robotics. The scarcity is partially explained by the design issues which are governed by application needs and skilled programming requirements. The designer, in a sense, has to reverse-engineer the problem, i.e., determine what microscopic interactions or basic behaviors are necessary to produce the desired collective behavior.

Ants exhibit collective behaviors in their navigation. Two main modes of navigation are observed in ant colonies. In the first mode a certain chemical called pheromone is secreted all along the path an ant travels. Pheromones are special chemical substances secreted by the ant during motion to convey information that it has followed a particular route. Pheromone concentration has the ability to decay (evaporate) with time. Ants tend to follow routes rich in pheromone concentration.

An ant has the ability to emit its pheromone when it crosses an object of interest (a food particle etc). These pheromones act as beacons for followers or others to decipher their future route. Ants gather their nest mate's pheromone trail information to devise their future foraging or navigational strategy. Certain ants, as they return to the nest with food, lay down a trail pheromone. This trail attracts and guides other ants to the food. It is continually renewed as long as the food holds out. When the supply begins to dwindle, trail making ceases. The trail pheromone evaporates quickly so other ants stop coming to the site and are not confused by old trails when food is found elsewhere. A stick treated with the trail pheromone of an ant can be used to make an artificial trail with is followed closely by other ants emerging from their nest. Other ants will not maintain the trail unless food is placed at its end.

Though much of literature regarding ant navigation has a pheromone-based approach, other means of ant navigation methods also exit in literature. A second mode of navigation utilizes cognitive or visual cues whereby information is collected during foraging which may be utilized to embark on future routes. This navigation technique has been reported in Polyrhachis laboriosa or tree dwelling ants. In this type of motion seen in certain ant colonies, visual cues acts as a means for the individuals to evaluate their position with respect to certain known coordinates (usually the nests). This can be done in two ways: path integration and cognitive vision (the ability of the ants to remember positions en-route during motion).

The pheromone-based aspect of ant motion, in particular, was investigated by researchers in most ant species and has been applied to most practical and optimization problems. The famous traveling salesman problem (TSP) and the quadratic assignment problem are examples where solutions were inspired by knowledge of ant pheromone trails. Routing in communication systems is another important and interesting application where ant based optimization algorithms has been successfully applied.

Mine detection is another such example. Mine detection is the process of detecting known or unknown mines over a minefield, so they can be removed or defused. The number of people killed by land mines is ever increasing. It is believed that, on average about 70 people are directly killed or maimed each day by them. This amounts to more injuries and deaths than are attributed to ICBMs or nuclear weapons combined. In fact, there seams to be more international conventions and laws on ballistic and nuclear arms than land mines. Land mines are one of the most lucrative weapons for war or terrorism due to their low cost and ease of deployment. It is believed that, on average, as many as 110 million remain planted, with more than eighty percent of these found in Asia and Africa alone. It is estimated that, at the present pace of clearing mines, another thousand years would be consumed in de-mining them completely if no more planted during this same period.

Land mines are typically placed in rugged terrains, such as hilly regions, mountain slopes, river beds, forests, etc. which makes removal more difficult. A vast majority of the mine removal process directly involves human intervention, resulting in greater causalities. Because land mines are normally found in third world countries, a lack of available funds for removal is one reason for increased human intervention. While an automated mine detection and removal system may not seem cost effective compared to conventional practices, it could certainly avoid the direct involvement of humans.

The standard set for humanitarian de-mining is 99.6 percent guaranteed clearance by the ‘Humanitarian Demining Development Programme’ for any successful mine detection implementation on actual minefields. A growing concern for international peace and stability is the use of mines both in war and defense. Traditional or classical techniques of control engineering were primarily used for the technologies involved in this area, but due to a recent boom in distributed control, a trend has emerged which advocates the use of independent agents (usually multi-agents) in de-mining. The adaptation of a particular trend in the field of de-mining has not been easy, and much scrutiny will understandably be involved in any decision to adopt a particular technology due to the sensitive nature of the issue.

Land mine detection still uses contemporary techniques at practical levels. These techniques can be crude, costly and directly involve humans being exposed to dangerous chemicals and explosive during the de-mining process. Research has been made in terms of applying robots or un-manned vehicles for solving the task, such as the minerats used by the Demining Technology Center (DeTec) at the Ecole Polytechnique Federale De Lausanne (EPFL), Swiss Federal Institute of Technology, Lausanne, Switzerland. There are models posed by researchers for the mine detection problem with the aid of swarm intelligence, most of which use pheromonal-based foraging techniques. Other research models employ distributed control techniques outside swarm intelligence applied to cooperating robots aimed at mine detection. Such systems include models based on artificial immune systems, distributed heuristics, genetic algorithms, and other bio-inspired computing approaches.

Despite the various advancements in addressing the mine detection problem, there remains a need to enhance the swarm-based approach in order to provide a building block for real-life mine detection systems specifically, as well as other applications in which foraging for targets can be applied. The present invention is directed to meeting these needs.

### BRIEF SUMMARY OF THE INVENTION

The present invention provides a swarm intelligence based approach to target location in general, and mine detection in particular. This can be enhanced through the integration of cognitive mapping and memory into the foraging process, thus enabling the ants, or scouts, with the ability to store, remember and process en route information to achieve newer foraging routes and future destinations during the mine detection process.

Thus, in one sense, the present invention provides a method of locating targets dispersed within a target field. According to this methodology, a plurality of like robotic scouts are provided. Each robotic scout is designed to traverse the target field's terrain, detect an existence of each target when in a vicinity thereof, transmit a target detection signal upon detecting existence of a target, and receive the target detection signal when transmitted by another one of the robotic scouts in order to follow the signal's associated intensity gradient.

Also according to this methodology, the target field is foraged with robotic scouts until each of the targets is located. Each of the robotic scouts forages according to a navigational scheme. This navigational scheme entails stochastically navigating the terrain prior to receipt of the target detection signal, and deterministically navigating the terrain following receipt of the target detection signal. During deterministic navigation, the intensity gradient of the received target detection signal is followed until the selected target associated with it is detected, whereupon the selected target is deemed located. The navigational scheme further entails scouts remaining at the selected target until for some selected time duration (such as a threshold time of approximately 30 seconds) or a requisite number of other robotic scouts (preferably three in the simulations), arriving at the selected target. Thereafter, foraging of the target field is resumed according to this navigational scheme.

A method of emulating detection and diffusion of mines within a minefield is also provided. According to this method, the display device of a computer system is used to simulate a plurality of randomly dispersed mines within a boundary corresponding to a periphery of a minefield. A plurality of like robotic scouts having the design and navigational capabilities discussed above are simulated on the display device. Mine diffusion is deemed to occur once the requisite number of other simulated robotic scouts arrive at the selected mine location.

Also contemplated is a method of locating targets dispersed within a planar target field arranged as a square matrix, wherein each of a plurality of like robotic scouts has a capacity for cognitive memory and is additionally designed to store a cognitive map of the target field that is characterized by a plurality of distinct cognitive regions. These cognitively programmed robotic scouts have the design and foraging capabilities discussed above. However, due to the incorporation of cognitive napping and cognitive memory, when they resume foraging of the target field they are capable of behaving somewhat differently in order to expedite the target location process. That is, such robotic scouts resume foraging of the target field according to a revised navigation scheme whereby an associated new route is embarked upon based upon a computed probability distribution which takes into account previously logged navigational date pertaining to target locations, and which indicates that the probability of encountering another target along the associated new route is greater when compared to other optional routes.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIGS. 1(a)-(d) are time sequenced computer screen shots which representatively depict robotic scouts foraging for targets in a simulated minefield;

FIG. 2 is a perspective view of a representative robotic scout;

FIGS. 3(a) & (b), respectively, show the power layer for the representative robotic scout of FIG. 2 and its associated power layer schematic;

FIGS. 4(a) & (b), respectively, show the communication layer for the representative robotic scout of FIG. 2 and its associated communication layer schematic;

FIGS. 5(a) & (b), respectively, show the infra-red layer for the representative robotic scout of FIG. 2 and its associated infra red layer schematic;

FIGS. 6(a), (b) & (c), respectively, show the ultrasonic layer for the representative robotic scout of FIG. 2 and an associated ultrasonic layer schematic;

FIG. 7 shows a schematic for the control layer of the representative robotic scout of FIG. 2;

FIG. 8 shows a state transition diagram for the scouts in the mine detection model;

FIG. 9(a) is a table representing the conditions which occur for the scouts to transition between the states diagrammed in FIG. 8;

FIG. 9(b) is a table representing the actions to be taken by the scouts as they transition between the various states shown in FIG. 8;

FIG. 10 is a high level flowchart for illustrating some of the principle features of the mine detection process;

FIG. 11 is a graph of a representative scent distribution curve;

FIG. 12 diagrammatically illustrates overlapping regions when a plurality of scent distributions interact;

FIG. 13 diagrammatically represents a minefield divided into distinct cognitive regions and cognitive sub-regions;

FIG. 14(a) is a graphical plot, for a 96×96 size field, showing the simulated completion time for the mine detection process, as a function of both the number of scout employed and the number of mines planted;

FIG. 14(b) is a graphical plot, for a 48×48 size field, showing the simulated completion time for the mine detection process, as a function of both the number of scout employed and the number of mines planted;

FIG. 15 plots, for both scouts with and without cognitive memory, of the rate of mine detection as a function of the number of mines defused;

FIG. 16 plots, for both scouts with and without cognitive memory, the freezing curve characteristics for the mine detection system;

FIG. 17 plots, for both scouts with and without cognitive memory, a comparison of the reduction factor to the knowledge ratio;

FIG. 18 plots, for both scouts with and without cognitive memory, the iteration factor versus the threshold time a scout is allowed to remain in the waiting stating before resuming foraging activities;

FIG. 19 plots the effect of finite lifetime for the scouts on the performance of the system; and

FIG. 20 plots the effect of finite memory on the performance of the system.

### DETAILED DESCRIPTION OF THE INVENTION

The present invention preferably applies a swarm intelligence based, ant colony optimization model for simulating a solution to the mine detection problem. Navigation over unknown terrains has always been complicated and is also very sensitive in the mine detection problem. Literature found on navigation in ant colonies has been focused primarily on pheromone-based approaches to the mine detection problem. The present invention endeavors to both expand upon these approaches and additionally corporate a newer concept, namely cognitive mapping, into the foraging techniques. While the preferred embodiment of the invention focuses on mine detection, other optimization problems such as the traveling salesman problem, quadratic assignment problem, network routing, clustering and pattern recognition etc are also contemplated. Other domains that could benefit from the teachings herein are in agent theory, e-commerce, operations research etc. Indeed, it is contemplated that the teachings of the invention can provide a building block specifically for mine detection, but also more generally to other applications which can benefit from a swarm intelligence based approach to target location.

One issue that still remains central to the mine detection task is the applicability of multiple robots or entities for its execution. A global algorithm based on natural heuristics is likely needed. Natural heuristics is control theory designs and models originating for natural phenomenon. One such model is the ant colony model which endorses distributed, simple and autonomous ants (referred to herein as “scouts” or “agents”) cooperating, and at times competing, with each other to realize a global task. A unique aspect of the simulated approach described herein is from the inculcation of cognitive maps in the foraging and detecting aspects of the model, specifically for the mine detection task. Cognitive maps are orientation diagrams representing accumulated and dynamic information with the individual scouts that are employed for the mine detection process.

In the following detailed description, reference is made to the accompanying drawings which form a part hereof, and in which is shown by way of illustrations specific embodiments for practicing the invention. The leading digit(s) of the reference numbers in the figures usually correlate to the figure number; one notable exception is that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Aspects of the present invention may be implemented on a general purpose computer that typically comprises a random access memory (RAM), a read only memory (ROM), and a CPU. One or more storage devices may also be provided. The computer typically also includes an input device such as a keyboard, a display device such as a monitor, and a pointing device such as a mouse. The storage device(s) may be large capacity permanent storage such as a hard drive, or a removable storage, such as a floppy disk drive, a CD-ROM drive, a DVD-ROM drive, flash memory, a magnetic tape medium, or the like. However, the present invention should not be unduly limited as to the type of computer on which it runs, and it should be readily understood that the present invention indeed contemplates use in conjunction with any appropriate information processing device, such as a general-purpose PC, a PDA, network device or the like, which has the capability of being configured in a manner for accommodating the invention. Moreover, it should be recognized that the invention could be adapted for use on computers other than general purpose computers, as well as on general purpose computers without conventional operating systems.

The results have been tested at the simulation level using Matlab (Version 6) running on a Windows® machine, and code for the simulation is located on the submitted compact disc under the file name “Matlab”. The ordinarily skilled artisan will appreciate that the programming could be developed using several widely available programming languages with the software component(s) coded as subroutines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventor should not be interpreted to limit the environment of the present invention.

Software embodying the present invention may be distributed in known manners, such as on computer-readable medium which contains the executable instructions for performing the methodologies discussed herein. Alternatively, the software may be distributed over an appropriate communications interface so that it can be installed on the user's computer system. It should, thus, be understood that the description to follow is intended to be illustrative and not restrictive, and that many other embodiments will be apparent to those of skill in the art upon reviewing the description.

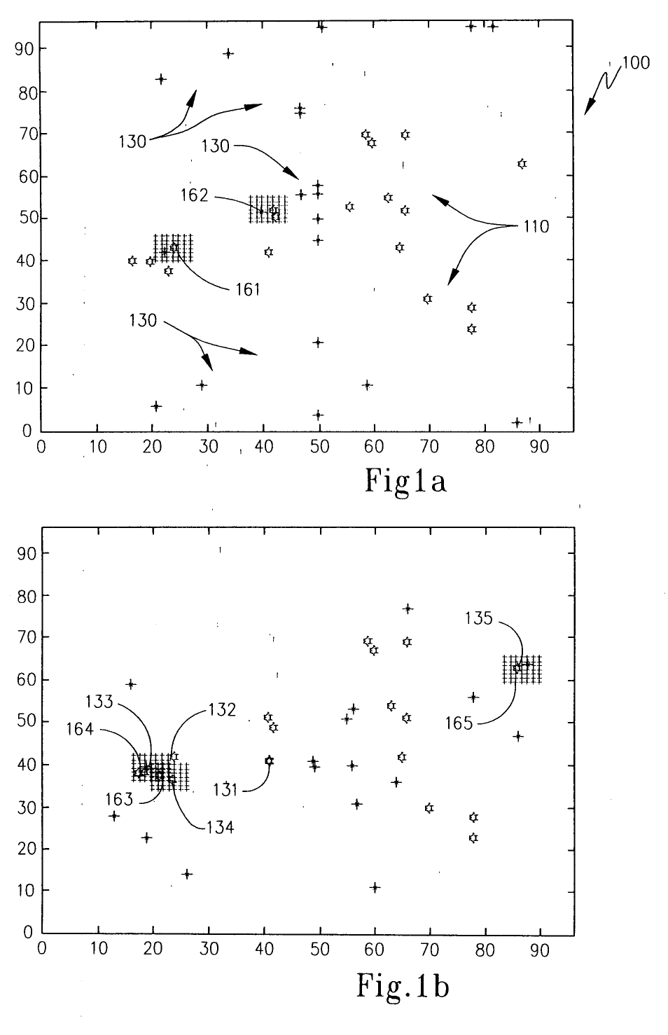

FIGS. 1(a)-1(d) are each computer screen shots representatively showing simulation results obtained as a plurality of scouting ants forage for mines over a minefield, in accordance with the navigation scheme described herein. FIGS. 1(a)-1 (d) portray various snapshots of the simulated mine detection process at a variety of points in time. For purposes of introduction, though, initial reference is made only to FIG. 1(a) which shows a simulated planar minefield 100 that is a square 96×96 matrix. Randomly dispersed within the minefield 100 are a plurality of mines 110. Eighteen such mines are shown. Also illustrated are a plurality of ants 130 foraging for the mines. Twenty such ants are shown. Each shaded region, such as regions 161 and 162, represents a scent distributed by a particular ant once it encounters a mine. In practical terms, the two dimensional scent distribution would have a circular pattern, so that the ordinarily skilled artisan will appreciate that the rectangular depictions in the various figures are representative only.

While the derivation for the simulation described herein is preferably directed at addressing the mine detection problem through swarm intelligence-based techniques, the artisan should appreciate that these concepts can be extended to other applications. Accordingly, the “mines” discussed in the context of the preferred embodiment can more broadly be considered as “targets”. Similarly, the more encompassing term “scouts” or “robotic scouts” will be used at times interchangeably with the term “ants”.

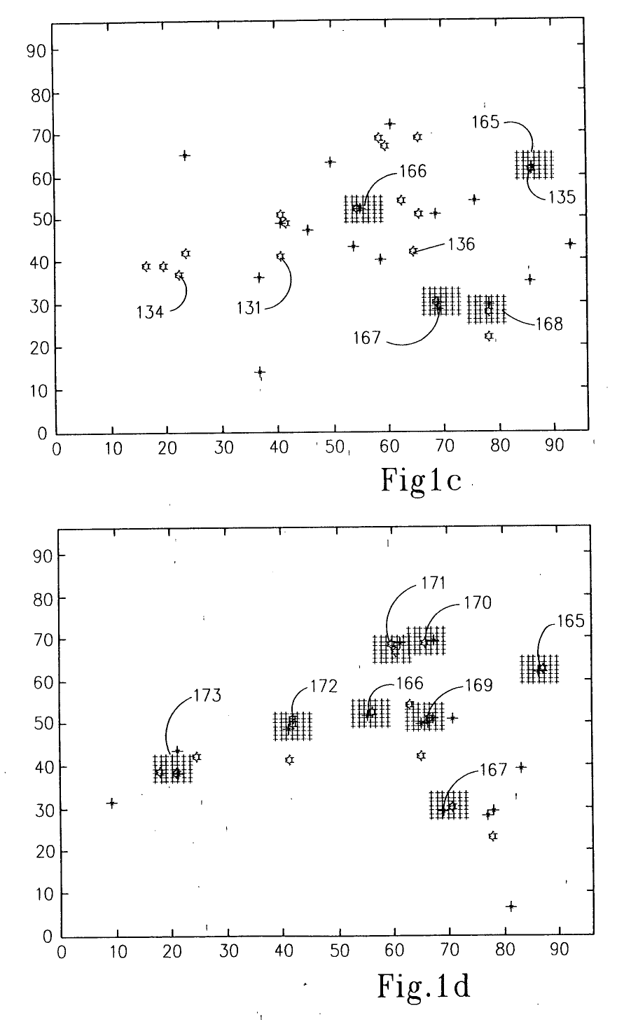

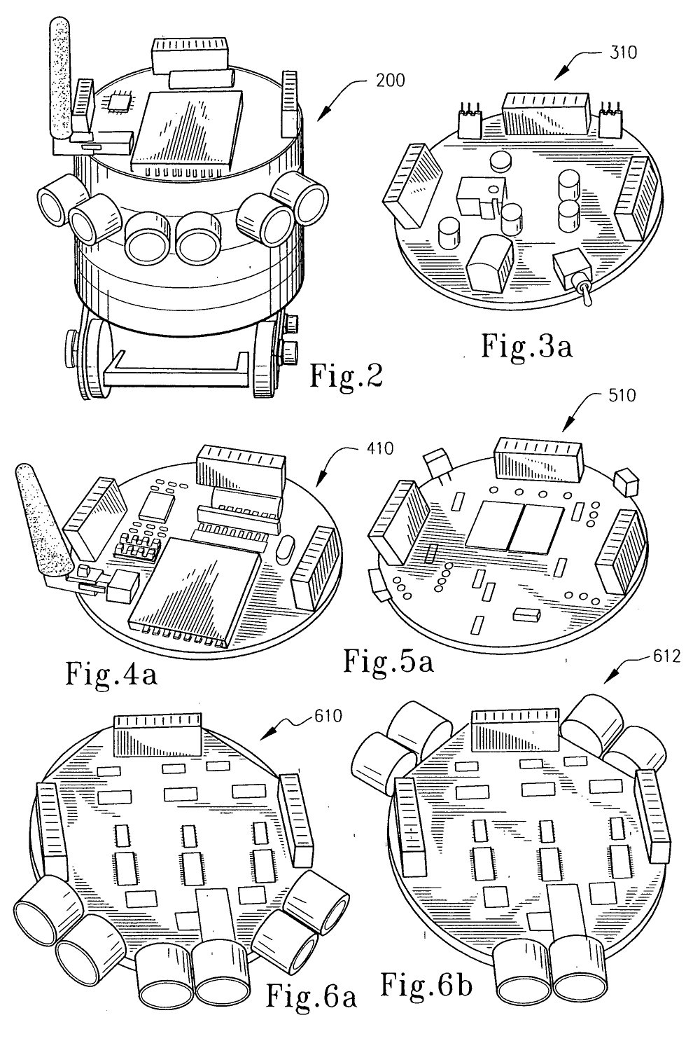

Each “ant” in the simulation shown in FIGS. 1(a)-1(d) can be realized in practical terms by a robotic scout 200, such as shown in FIG. 2. Indeed, a plurality of like robotic scouts 200 has been deployed on a planar rectangular surface measuring approximately for the purpose of detecting randomly dispersed targets (mines) which can be sensed by the robots. Though somewhat simplistic at first blush, this physical application of the simulation has served to confirm the potential viability of the mine detection technique in a real world application. Indeed, provided that known or future developed robotic scouts are appropriately designed to traverse the terrain of a real world minefield, it is believed that the navigational scheme described herein, when programmed into the robotic scouts, can enable mine detection and eventual removal/defusion to occur in a manner which reduces risk to humans.

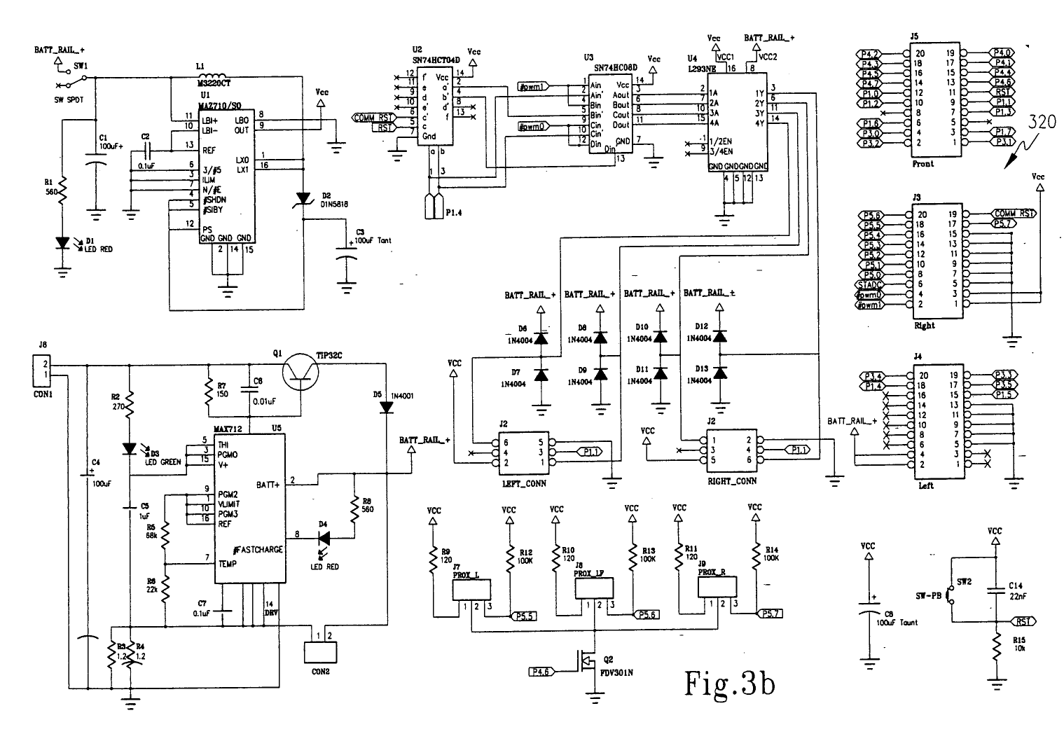

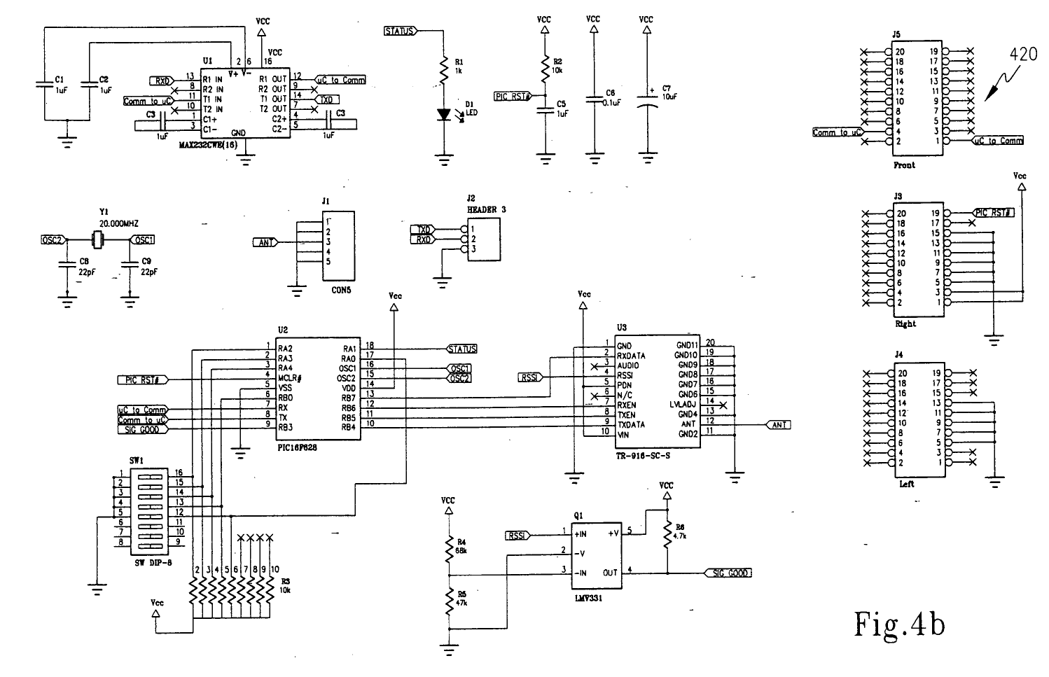

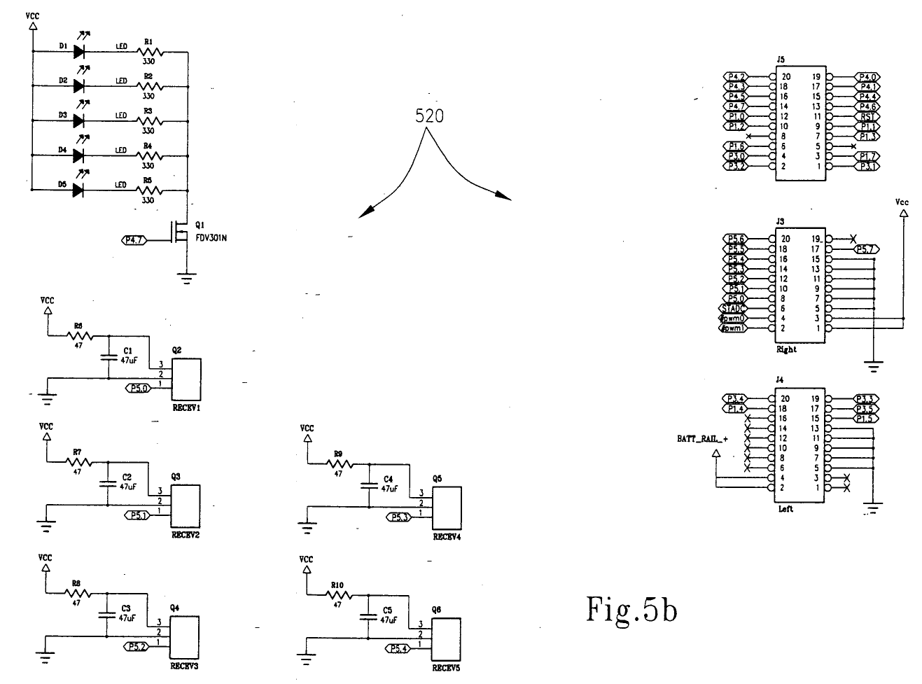

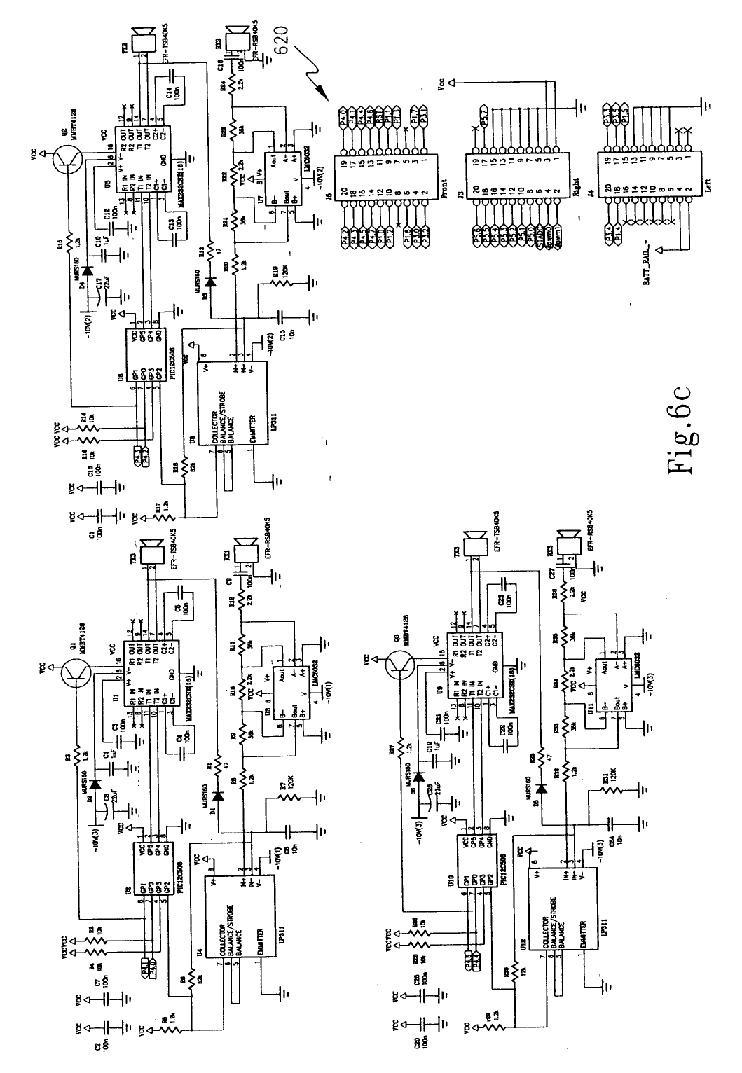

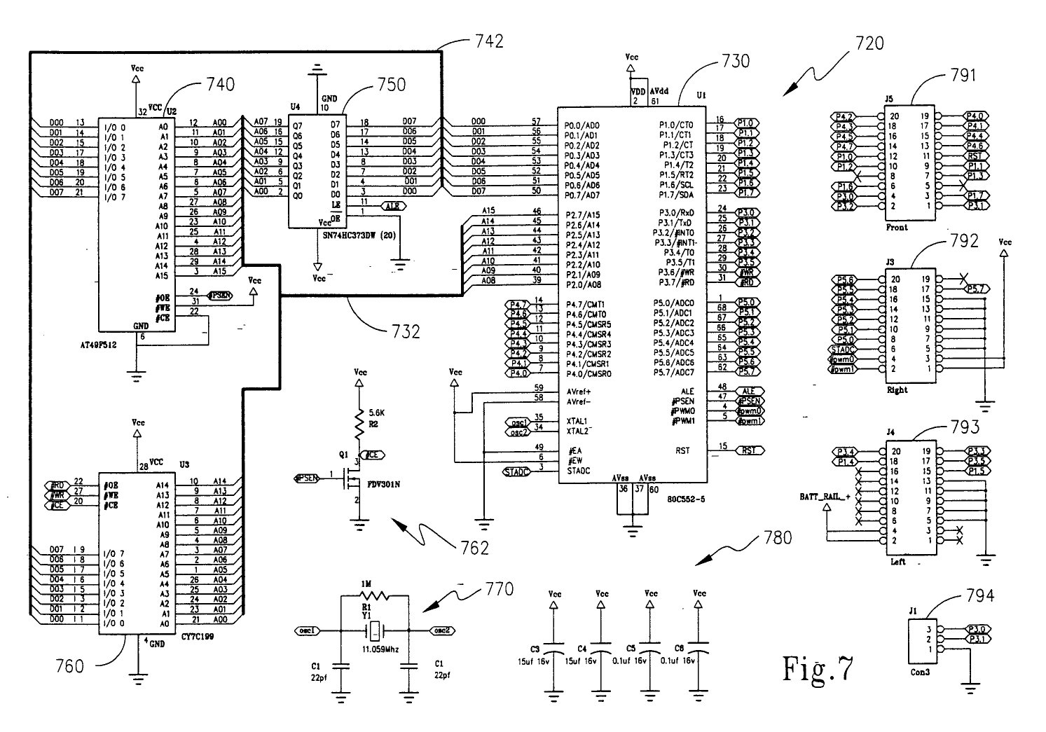

With the above in mind, representative robotic scout 200 may be constructed as a plurality of distinct and interconnected layers each serving a particular purpose so that the robotic scouts 200 can traverse the field, sense targets, and communicate with one another. Six such layers may be provided, and five of these are diagrammatically shown without detail in FIGS. 3-7 for illustrative purposes. FIGS. 3(a) and 3(b) respectively show the power layer 310 for the robotic scout 200 and its associate power layer schematic 320. The communication layer 410 and its associate communication layer schematic 420 are shown, respectively, in FIGS. 4(a) and 4(b). An infrared layer 510 may be employed for use in transmitting and receiving target detection signals amongst the scouts. Infrared layer 510 and its associated schematic 520 are illustrated in FIGS. 5(a) and 5(b), respectively. The ultrasonic layers 610, 612 and their associated schematic 620 are, respectively, shown in FIGS. 6(a), 6(b) & 6(c). It should be noted that since the representative robot shown is one of a plurality of like robots which communicate cooperatively, a communication layer such as layer 420 need not be provided. However, since the representative robot may be universally used for a variety of applications apart from mine detection, or in the event one wanted to provide for such communication capabilities in a mine detection application, a communication layer is provided. Also in the representative robot of FIGS. 2-7, two ultrasonic layers can be employed, each having its own sensor orientation. One layer, 610 in FIG. 6(a), has sensors only in the front and is capable of comparatively precise sensing in the forward direction, while the other layer, 612 in FIG. 6(b), has circumferentially distributed sensors for multi-directional sensing. The ultrasonic sensors are provided for obstacle avoidance during navigation. Finally, a schematic 720 is shown in FIG. 7 for a control layer.

Since the present invention contemplates that a plurality of robotic scout designs could be employed, with the design parameters dictated in large part by the minefield environment (terrain, atmosphere, cost, etc.), a detailed explanation of the various layers for representative robotic scout 200 need not be provided. The ordinarily skilled artisan, however, who is suitably versed in the field of robotic design should readily appreciate the construction of representative robotic scout 200 from the figures herein.

A more detailed explanation, however, is provided with respect to the schematic for control layer 720 since it receives and communicates the instruction set for the pre-programmed navigation scheme described below. It should be appreciated that the schematic of FIG. 7(b) shows the control layer for a versatile robot, such as the scout robot 200 of FIG. 2, which can be programmed to provide a variety of different operations, among which is the mine detection capability discussed herein. Thus, control layer 720 is representative and not limiting in relation to the mine detection problem. With this in mind, control layer 720 includes a microcontroller, such as part no. P80C552EBA available from Philips Semiconductors. Microcontroller 730 communicates with a flash (EEPROM) 740 via a latch 750. Flash 740 may be part no. AT49512-70PC-ND available from the Digikey Corporation of River Falls, while latch 750 may be part number 296-1200-5-ND, also available from the Digikey Corporation.

Although not needed in the present implementation, an additional RAM chip 760 is provided on control layer 720 to provide accommodation for additional memory resources if needed. A program select capability 762 is provided to transition between memory chips, if needed. Clock signals are provided via oscillator sub-circuit 770, and signal filtering capacitors 780 are provided to shunt unwanted noise. Finally, control layer 720 also incorporates a plurality of jumpers 791-794 to provide a suitable interface between it and the remaining layers for the scouting robot shown above.

In operation, and as is known in the art, address lines 732 of microcontroller 730 are used to fetch the stored code from EEPROM 740, which transmits the instruction set via data lines 742 to the microcontroller for execution. To this end, Keil Software development tools for the 8051 microcontroller family, available from Keil Software, Inc. of Piano, Tex. were used to program the instruction set in the C programming language. With this integrated development environment, the instructions set can then be compiled into an executable hex file and burned onto the EEPROM 740 via a TopMax set up available from EE Tools Inc. Sunnyvale, Calif., or other suitable device programmer, all as is also known in the art. This instruction set is located on the submitted compact disc under the file names “Keil 1”, “Keil 2”, “Keil 3” and “Keil 4”.

Having described a representative robotic scout and introduced a simulation model for the present invention, the statistical analysis involved in deriving the navigation scheme for the scouts will now be discussed. Applicability of finite and variable lifetime for scouts during the process, variable threshold time to avoid freezing, and simulations results involving random sudden death (failure) of scouts are some of the other inculcations to the model which will be addressed.

A set of basic behaviors defined for an entity can produce complex behavioral patterns. These are the fundamental basis as described by Maja J. Mataric’ with regard to behavior-based agent modeling. A small set of primitive behaviors such as collision avoidance, trail following, dispersion, aggregation and homing (mostly seen in ant colonies) is sufficient to synthesize complex behavior, such as foraging and flocking, in a single robot or a group of robots. The mine detection application of the exemplary embodiment of the present invention maps to these behaviors which serves as fundamental components for synthesizing collective behavior. As a representative example, coalition formation relates to the ability of agents to convene a collection of agents or behaviors aimed at a specific local goal. Coalition formation is a desirable behavior in systems where a group of agents can accomplish a task more effectively than a single agent can. The tasks may be very different ranging from collective block pushing, to commuter ride sharing, to consumers forming buying clubs to purchase products in bulk in order to save money, yet the underlying mechanisms (mechanisms that bring about coalition formation) are always the same. Coalition-formation in a system of agents can result from two primitive agent strategies: dispersion or foraging and aggregation or recruitment. Dispersion is the ability of the agents to get distributed and search for a point of interest and aggregation is the ability to recruit partners at the point of interest. Dispersion allows the agents to explore the environment in which they are situated and to encounter other agents and coalitions. Once an agent encounters a coalition or arrives at a point of interest, it makes a decision about whether to join it (aggregate).

In the present invention, this type of foraging behavior has been applied to the scouts, which obviates the use of pheromone-like communication for their motion. The agents, or scouts, are considered to be individual ants performing the task of prey detection and retrieval. In both the simulation and the simplistic real world application referred to above, the task of prey detection corresponds to each robotic scout traversing the target field in search for targets. In the process of detection, each scout moves from the nest (or respective origin location) and performs an act of foraging and detection of randomly placed mines over a given area. The scouts move in a stochastic fashion while detecting the mines over the field. The mines are tantamount to the prey that the robotic scouts (which are all preferably identical in behavior, movement and design) have to detect over a field area. The scouts are given a foraging strategy in order to scout for the mines. When a scout reaches a mine it communicates a mine detection signal, such as an ultrasonic signal, to other robotic scouts. This is akin to the SRR (short range recruitment) found in certain ant colonies. Short range recruitment is the process by which an ant, when reaching a potential point of interest (food particle, foreign bodies, etc.), raises a potential alarm by spreading a secretive scent around it so that other foraging ants can arrive at the point of interest. This scent's intensity attenuates exponentially in a region around it. The spread of the scent is equivalent to physical stigmergy, which are basically physical changes produced in the environment so as to bring about a desired reaction, in this case attraction of other robotic scouts around the mine which follow the signal's increasing gradient and finally land themselves at the mine. Scent following is deterministic and no random movements are found inside the area covered with the scent.

Mine diffusion is simulated by requiring a selected number of scouts, such as four, to arrive at the mine's location. Thus, the mine would be eventually defused when the required number of scouts arrives at the mine's location. The problem is modeled in such a way that the attraction of the required number of scouts is prefixed. The simulation is not necessarily concerned with any sensory mechanisms that might be involved in the mine detection process either at the location of the mine or anywhere else. Contemporary sensory techniques can be implemented with the scouts to give them the ability to detect the mines.

The mine detection problem involves the simulated detection and the de-mining of randomly placed mines over a field by a finite number of scouting agents with resource constraints. The mines are randomly dispersed over a field (96×96 units), such as in the simulation depicted in FIGS. 1(a)-1(g). An important aspect for measuring success is guaranteeing 100% mine detection in a timely manner. To this end, it is assumed in the simulation both that the field size over which the mines are distributed and the number of mines to be defused is known, as this could be useful in designing the cognitive maps the robotic scouts carry.

The detection of any mine involves the collective actions of a certain number of scouts, four in the simulation. This need for a collective action of a certain number of scouts for de-mining brings the recruitment mechanisms into the picture. It is envisioned, then, that in a real world application a plurality of robotic scouts may be needed to defuse, or perhaps remove, each mine that is located. Accordingly, the simulation factors this into account by not considering any given mine to be defused until a requisite number of scouts arrives at its location. It should be noted that diffusion is not a particular focus of the present application, but rather the simulation of it.

One approach for addressing the mine detection problem utilizes a combination of both deterministic and stochastic methods. A deterministic method is a method that has a predetermined plan of action as opposed to stochastic methods where decision depends on random choices made at different points of time. The stochastic component is brought in only in the foraging stage, while the stage when a scout enters a scent area it does not behave stochastically, but rather in a deterministic manner. It simply follows the route, which has an increase in the scent, and since the intensity of the scent supposedly peaks at the mines, the scout eventually finds itself at the mine. The behavior of the scouts can be put in as a state machine representation.

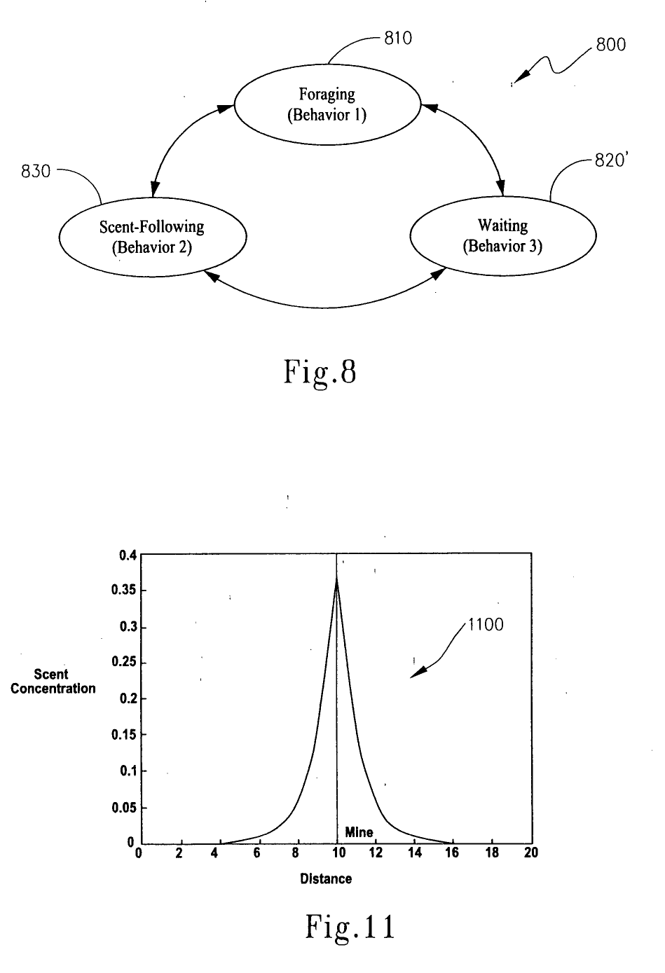

A state transition diagram 800 for the mine detection model is shown in FIG. 8 where it may be seen that the scouts have three basic behavioral states, foraging 810, waiting 820 and scent following 830. The scouts may transition back and forth between each of these states, as indicated by the dual-direction arrows in FIG. 8. From the state diagram it can be seen that scouts can proceed from one state to the other state for any combination of two states under some conditions. The foraging behavior represents the state where a scout is searching for a mine over the minefield. Scent following denotes the state where the scout follows a scent distribution caused by a fellow scout at a mine location and the waiting state denotes the phase wherein a scout at a mine waits for the required number of fellow scouts to arrive.

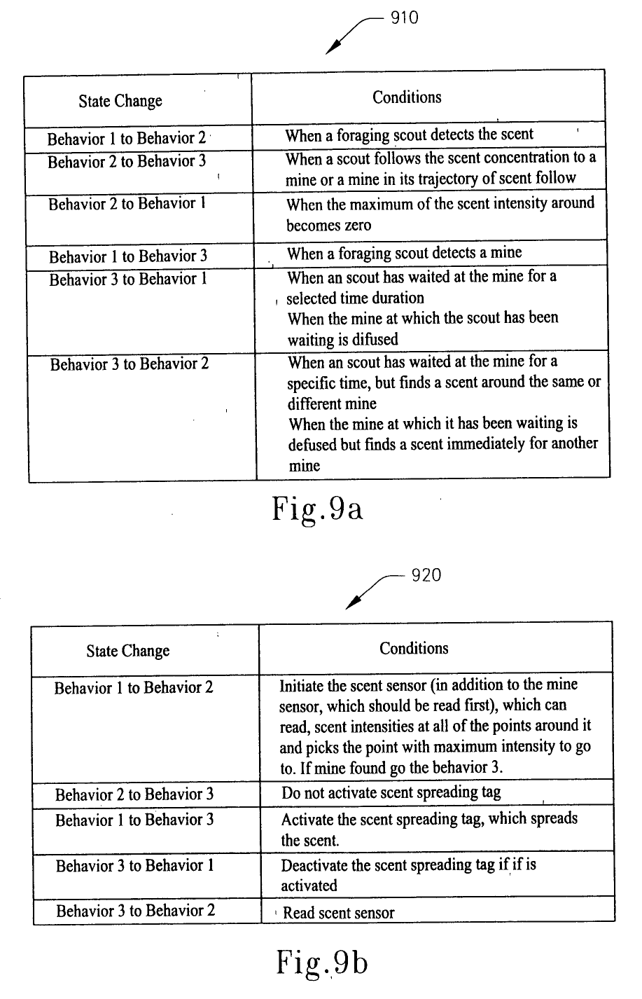

Conditions which dictate these state transitions are described in the table 910 of FIG. 9(a). It may be appreciated then, for example, that a scout transitions between the foraging state (behavior 1) to the waiting state (behavior 3) when it detects the existence of a mine. Appropriate sensors, such as the infra-red sensors discussed above can be incorporated into the robotic scouts to detect a mine. The scout will only return to the foraging state when it has either waited at the mine for a selected interval of time or until the mine is defused. If during either of these situations the scout detects a scent, it will instead transition from the waiting state (behavior 3) to the scent-following state (behavior 2).

FIG. 9(b) shows a table 920 which identifies the various actions to be taken by the scouts once they transition between the various states. Thus, for example, when the scout transitions from the scent-following state (behavior 2) to the waiting state (behavior 3) it deactivates scent spreading. In a real world application this might correspond, for example, to the robotic scout ceasing to transmit a communication signal (audile, visual or otherwise) so that it is no longer detectable by other scouts. The artisan will, thus, appreciate that the term “scent” as used herein, while necessarily being derived from the pheromonal activity of ants, contemplates any appropriate signaling transmission and signaling reception suitable to a robotic implementation of the invention.

When a scout reaches a mine (and detects it using any of the contemporary mine sensing techniques) it spreads a scent around the mine. The other scouts around the mine follow the scent's increasing gradient and finally land themselves around the mine. The scent decay in the simulation can be described by the following equation:
S(x, y)=Ae^{(-α(Min((x-x}^{₁}^{),(y-y}^{₁}⁾⁾⁾⁾ (1)

In the above expression, S is the scent intensity at any point (x,y) on the minefield, the point (x₁,y₁) is the location of the mine, while A and a are constants. For purposes of the simulation, A is 1 and α is 0.3.

An important point that should not be overlooked during the process is when all of the scouts go into the state of waiting (Behavior 3), expecting for the others the come at the respective mines. Such a situation can happen when the ratio of the number of scouts involved in the detection process to the number of mines deployed is relatively small. There are a number of other factors that can dictate the occurrence of such a phenomenon. Some of them are the field size, the initial distribution of the mines, etc. Such a situation can be called freezing, where there is no motion of the scouts, as they are each waiting infinitely for the others.

In the mine detection problem, the phenomenon of freezing could be avoided, by enabling the scouts to have a threshold time to wait at the mine. If the required number of scouts (in the simulation, four) does not arrive within the stipulated time (the threshold waiting time, (50 step counts) in the simulation) the scout leaves the mine and resumes its foraging behavior. For the simulation to have an even platform, the scouts are programmed to have a scent-spreading ability, which is their capacity to spread a scent distribution with the mine being the center and the concentration of the scent attenuating over spatial distance. The scent-spreading ability is activated when the scout locates a mine without the help of the scent of any other scout, and irrespective of other scouts waiting at the particular mine (that is, only a behavioral change from foraging to waiting can directly activate the scent spreading ability). Only the scout that has scent spreading activated has the ability to quench the scent when it decides to stop waiting and resume foraging. The scouts which are in the waiting state but do not have their scent spread activated can resume foraging only when either: (1) the mine is defused, or (2) at a time when no other scent spreading scout is around the mine spreading the scent.

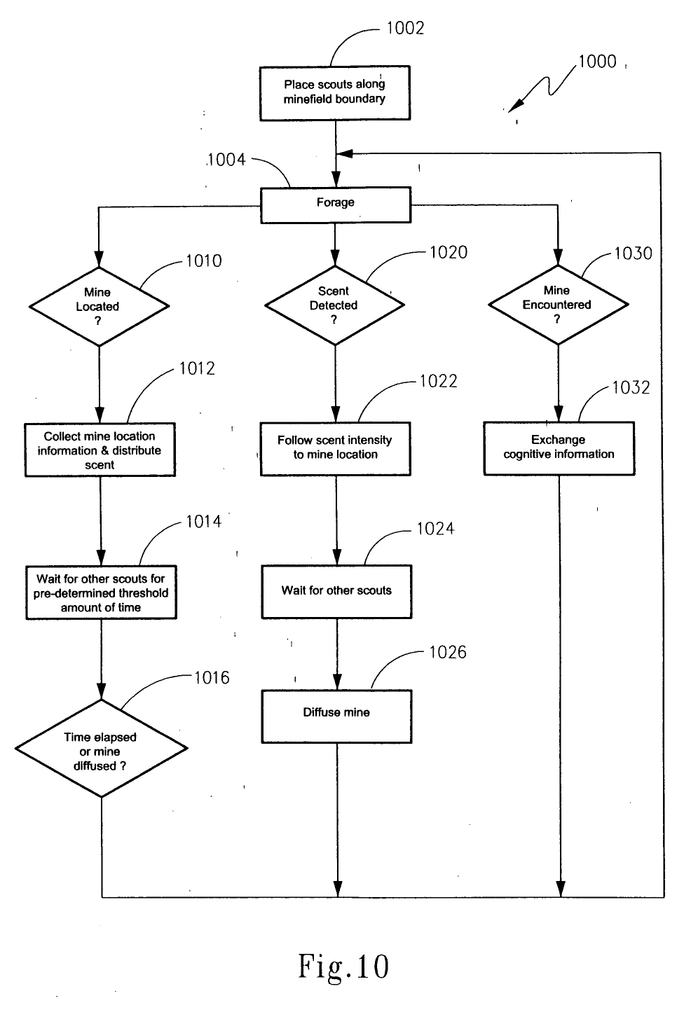

Another aspect not to be overlooked is the amount of time that any scout should be allowed to wait at a particular mine. This can be a function of the probability of any scout being found at a particular spot on the field per unit time, the number of scouts, the number of mines etc. By employing this strategy, a general understanding of the solution to the overall mine detection process can be appreciated with reference to the flowchart in FIG. 10.

One embodiment for the mine detection methodology 1000 begins at 1002 upon the placement of the robotic scouts along the minefield's boundary. The scouts are allowed to forage for mines, scent distributions, or other scouts at 1004. If a mine is located at 1010, information is collected about the mine's location at 1012, and the scout then begins at 1014 to wait, for a predetermined threshold amount of time, for other scouts to arrive at the mine location. Once the threshold time either elapses, or the mine is defused at 1016, the scout resumes its foraging activities at 1004.

If, during foraging, a scent distribution is found at 1020, the scout begins to follow the increasing scent intensity at 1022 to ultimately arrive at the location of a mine detected by another scout. Once the mine is located, the scout goes into the waiting mode at 1024 in order for the requisite number of other scouts to arrive so that the mine can be defused at 1026. Foraging activities are then resumed at 1004. If, while foraging, another scout is encountered at 1030, the scouts can exchange their cognitive information at 1032 in the hope that location of any undetected mines might proceed more efficiently.

When the mines are densely concentrated over the field, there may be instances where two or more scents can overlap. In such instances, the algorithm should ensure that the peaks in scent intensity occurs only at the mines and that there are no, or very few, local maxima in the overlap region which may mislead scouts within the scent area as they move toward the increase in scent concentration. Local maximums in this context are highly concentrated scent locations which do not have a mine and could be a cause for a potential risk for a false alarm. They are usually formed when two or more scent spreads are added in the overlap regions. Local maximums, which can normally occur in the overlap region, could be detrimental in restricting the movement of the scouts within the scent spread region. When local maximums occur within an overlapped region, scouts could be trapped in regions where there are no mines. This results in a temporary stoppage of the scouts' motion as they are made to falsely believe that the local maximum is the mine location. The scouts would try to move away from the local maxima when they sense that there is no mine in the location but would once again be pushed back to the same location due to their concentration gradient following nature in the trail following behavior.

Thus, there is a temporary unavailability of the scout which would resume for action only when the local maximum disappears. It should be noted that this will not lead to a false detection of mines as the behavior of scouts in the scent spread region is two-fold: scent following and sensing for mines. At the local maxima since there are no mines the scout would not go into waiting mode (behavior 3). Therefore, though this problem is not drastically detrimental, it needs to be considered in the overall interest of the problem.

An approach can be devised to minimize the scouts falling in the overlap region. The approach assumes that, if the scouts are to avoid (to a maximum possible extent) the overlap regions during navigation, they are less likely to be caught up at the local maximas occurring inside the overlap regions. The special scent distribution around a given mine may be represented by a falling two-dimensional exponential curve 1100, as shown in FIG. 11. The exponent for the curve needs to be less than 1 in the case when integers are used for raising the exponent. This may be good enough when there is no overlap in the scent regions, but when situations arise where there can be overlaps of the scent field, such as when two or more mines located relatively close to one another are detected by two scouts simultaneously or nearly at the same time, care should be taken in fixing the exponent for the scent distribution.

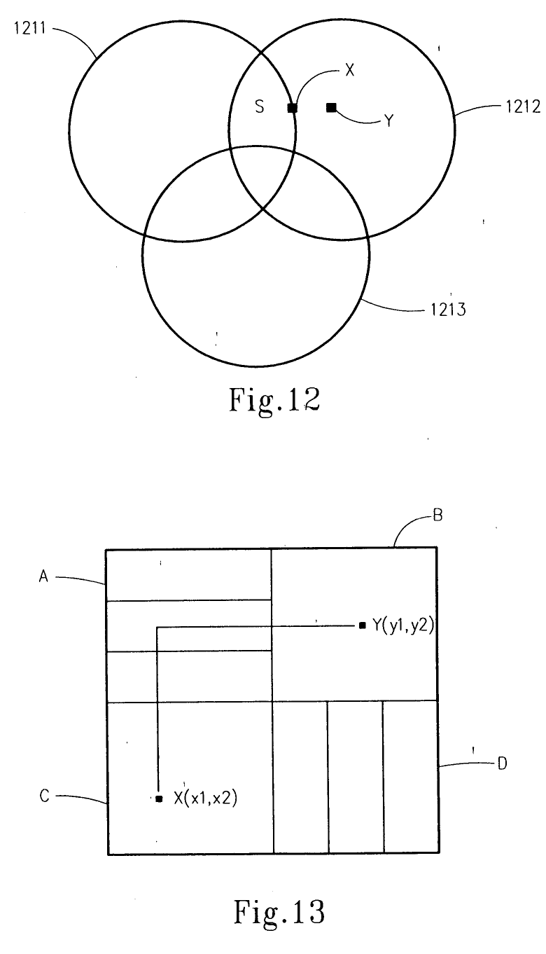

FIG. 12 illustrates a situation where overlapping has occurred for three scent distributions 1211, 1212 and 1213. In this illustration, the respective mines are located at the center of each respective circular region, with each respective scent peaking at the center and exponentially falling to the circumferential edge.

Assuming the exponential for each region 1211-1213 falls go according the function ƒ(x)=a^{x} for x values ranging from 0 (at the center of the mine) to m (the value it takes at the boundaries), then, if a lies in the range 0 to 1, m is the largest value that x can take. If a scout were to be prevented from entering an overlap region from outside (for e.g. preventing from entering sub-region “S” in FIG. 12), the scent concentration along the boundaries (e.g. point “X” in FIG. 12) should not be greater than that of the value just outside it (e.g. at point “Y” in FIG. 12).

Therefore,
aⁿ+1+a^{m}≦a (2)
where aⁿ is the scent contribution at point Y (point immediately outside the boundary) and a^{m} is the scent contribution at point X (point along the boundary). Scent contribution by independent regions are additive.
From (1)
aⁿ(1−a)≧a^{m} (3)

Taking the logarithm of both quantities of the inequality,
n log(a)+log(1−a)≧m log(a) (4)
(m−n) log(a)≦log(1−a) (5)
The worst case (the case when the quantity (m−n) log(a) is closest to the constant log(1−a)), can occur when n takes the value m−1
Substituting n=m−1 for inequality (4) above:
log(a)≦log(1−a) (6)
Therefore,
a≦1a (7)
This occurs only when a is in the range 0 to 0.5
It can be appreciated, then, that overlapping poses a constraint on the exponent that can be for selected for constructing the exponential fall for FIG. 11 above.

It can thus be appreciated that for condition (2) above to be valid, a (the exponent of the scent distribution) is preferably a number between 0 and 0.5, inclusively. For two overlaps, the range of values that the exponent can take becomes narrower. This trend is seen to happen, as there are chances of more than two overlaps happening. Thus the concentration of the mines poses a constraint in the value that the exponent of the distribution can take. The problem of analyzing the regions with more than one overlap grows exponentially with the number of overlaps. A common trend though observed is that the range of values that a can take becomes narrower as the number of overlaps increases, if the occurrence of a local maxi is to be avoided in the multi-agent system. A feature to be observed is that the area of the scent spread has no effect on the exponent of the distribution, though it can affect the number of local maxi.

Incorporation of cognitive maps (the orientation diagrams of information collected en route during foraging operations) and cognitive memory (memory required to point cognitive maps in the scouts) produces improved results in comparison to scouts whose motion is entirely random. The comparative results can be analyzed using simulation results obtained through runs conducted on fields of 96×96 and 48×48 with varying number of scouts and mines, as they were multiples of numbers used for field sub-sections and field maps. The foraging strategy for the scouts is in accordance with the cognitive maps. Cognitive maps are distinctive regions called cognitive regions on the minefield, which may or may not be mutually exclusive. FIG. 13 shows a field divided into distinct cognitive regions A-D. Each cognitive region, for example regions A & D, can be further divided into cognitive sub-regions. The scouts can be given the capacity of cognitive memory, which is the ability for them to retain information of mine locations. This information can then be used to devise foraging routes, resulting in more expeditious mine detection. Navigation of the scouts over the field, in the case of foraging, is basically roaming the cognitive regions. The processing of the information present in the cognitive maps controls the sub-regions that they visit during navigation. In the case of mine detection the processing should be aimed at optimizing the route so as to visit routes where the likelihood of finding mines is increases relative to other routes.

For example, let a_{1d}, a_{2d}, . . . a_{nd} and a₁ᵤ, a₂ᵤ, . . . aₙᵤ be the knowledge of the defused and un-defused mines, respectively, in regions A₁, A₂, . . . , Aₙ in cognitive region A on the field shown in FIG. 13. Similarly, let b_{1d}, b_{2d}, . . . b_{nd} and b₁ᵤ, b₂ᵤ, . . . bₙᵤ be the knowledge of the defused and un-defused mines, respectively, in regions B₁, B₂, . . . , Bₙ. Further, assuming the number of distinctive sub-region in a cognitive region is n, an ant would tend to select a new course according to the following probability distribution. A scout moving along a rectangular trajectory path from point X to point Y in the field is shown in FIG. 13. Let us assume the coordinates of points X and Y with respect to a certain boundary (assume the origin to be the lower left corner in the figure) is (x₁,x₂) and (y₁,y₂) respectively. The probability distribution function of the scout choosing its destination cognitive sub-region among various cognitive sub-regions is modeled as given in the following two equations:

$$\begin{matrix}P ( {y}_{1} ∈ {B}_{k} ) = \frac{1}{( 1 + β )} ( \frac{N - {b}_{kd}}{( n - 1 ) N} + β \frac{{b}_{ku}}{M} ) & ( 8 ) \\ P ( {y}_{2} ∈ {A}_{k} ) = \frac{1}{( 1 + β )} ( \frac{N - {a}_{kd}}{( n - 1 ) N} + β \frac{{a}_{ku}}{M} ) & ( 9 )\end{matrix}$$

In the above equations, β pertains to the degree of relative importance given to the information gleaned during previous foraging raids. It can be appreciated that, as β is increased, the relative importance of the information regarding the undefused mines overweighs those for the defused mine(s) in the probabilistic functions given in the equations. When β is unity, equal importance is given to both. The quantities M and N represent the total knowledge of the defused and undefused mines during foraging, and are shown in the following equations:

$$\begin{matrix}N = {\sum }_{k = 1}^{n} {a}_{kd} & ( 10 ) \\ M = {\sum }_{k = 1}^{n} {a}_{ku} & ( 11 )\end{matrix}$$

From the above results various observations can be made. Various simulation results conducted for the swarm intelligence algorithm will now be discussed. Most of these results indicate that incorporation of cognitive map information substantially improves performance in terms of the rate of detection. One important factor that any distributed system architecture, and for that matter swarm intelligence based models, has to be built on is adaptability. Adaptability is the virtue of the system by which it proceeds towards the optimal solution as time progresses regardless of initial position and condition.

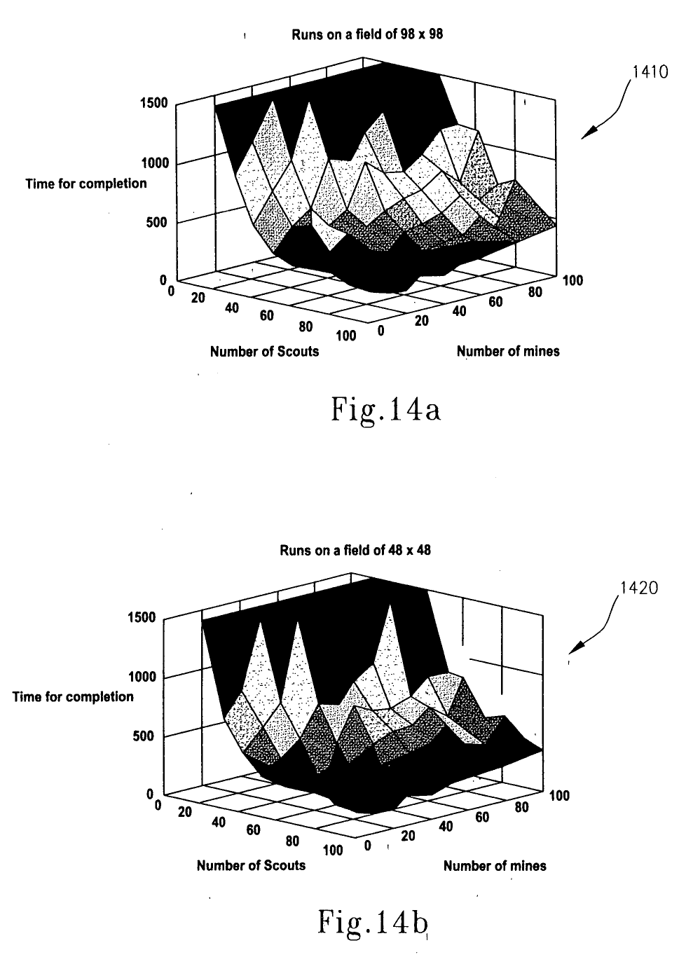

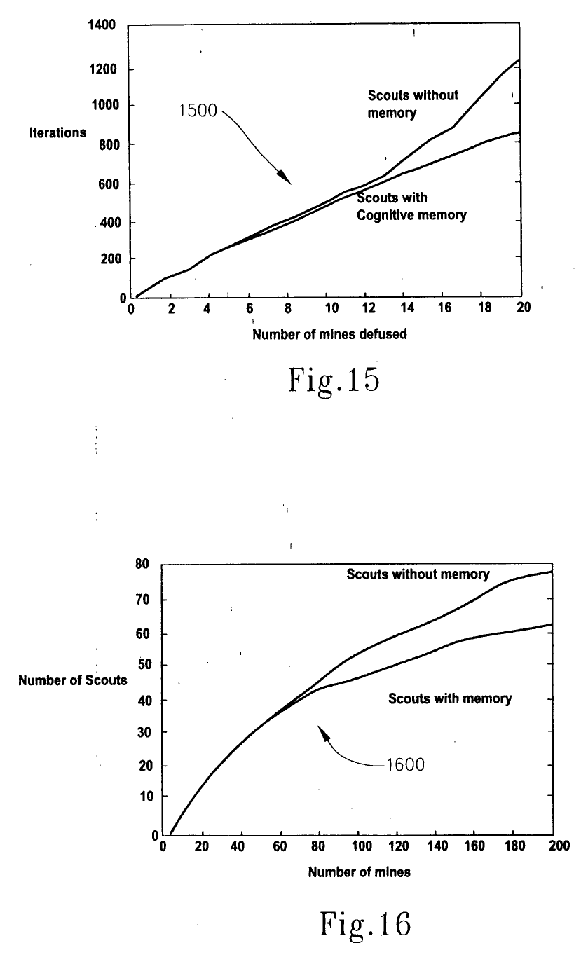

FIGS. 14(a) & (b), respectively, show simulation results 1410 and 1420 obtained for different field sizes, and specifically plot completion time as a function of the number of scouts and the number of mines. It should be noted that the plateau region in each figure is a result of the plots being intentionally cropped, and that the completion time understandably approaches infinity as the number of scouts and approaches zero and the number of mines approaches 100. Cropping has been done in these regions to facilitate the visual representation on of the results. The simulation results as plotted at 1410 and 1420 provide a basis for other analysis as plotted in FIGS. 15-20.

With this in mind, it is evident from the plot 1500 in FIG. 15 that the rate at which the mines are defused progressively increases in the case of scouts employed with cognitive maps, whereas it decreases or is stagnant in the case of those without cognitive maps. Decreases in the rate of mine detection as time progresses reflect randomness and increases in the rate shows adaptation. Thus, adaptability is evidenced in scouts employed with cognitive memory.

Another quantity that can be used to measure performance is the reduction factor. The reduction factor is defined as the ratio of the performance of the scouts with and without cognitive memory empowerment. The relation can be defined as follows:

$${T}_{r} = \frac{{T}_{f}}{{T}_{w}} \qquad ( 12 )$$

where T_{f} and T_{w} are the respective time iterations for completing a specific mine detection task by without and with memory. The reduction factor is significant tends to increase (as observed in simulation results) when the mines-to-scouts ratio is high, thus favoring the employment of cognitive maps in the foraging scouts under such situations.

FIG. 16 plots at 1600 the freezing curve characteristics of the system. The freezing curve dictates the boundary line dividing convergence of more than sixty percent and less than sixty percent of the times the simulation runs, assuming no threshold limit is applied to the waiting state. An important occurrence is that scouts with memory have significantly more convergence (as evidenced by the fact that the freezing curve for scouts with cognitive memory is below that of the randomly foraging scouts or those without cognitive ability) than scouts without cognitive ability. Thus, scouts with cognitive ability are deemed smarter than those without it when executing the task.

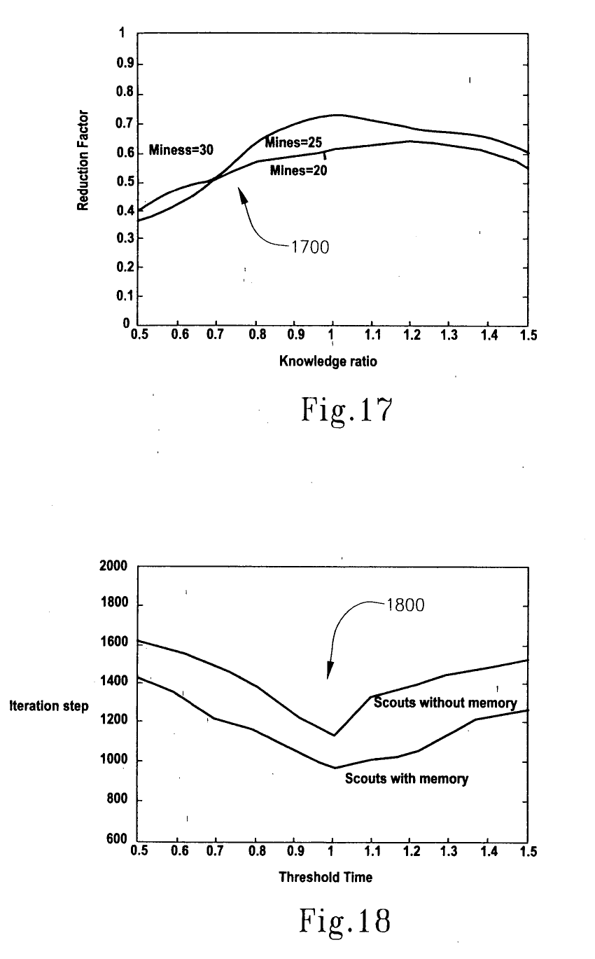

FIG. 17 plots at 1700 a comparison of the reduction factor to the knowledge ratio β. It can be observed that there is a maximum value for the reduction factor as seen in the simulation results. The maximum value signifies the highest point of adaptivity for the particular scout-mine ratio. On practical levels, when prior information on the number of scouts and mines is available, this observation proves very good in fixing the knowledge ratio β for obtaining maximum adaptability.

The next observation, plotted at 1800 in FIG. 18, shows the iteration factor versus the threshold time (the time that a scout is allowed to be in the waiting state before it resumes foraging activity). An important observation here is that a minimum iteration time (i.e. time for completion of the mine detection process) exists for a specific threshold time, which may vary with the scout-to-mine ratio. This point is the point of maximum adaptability.

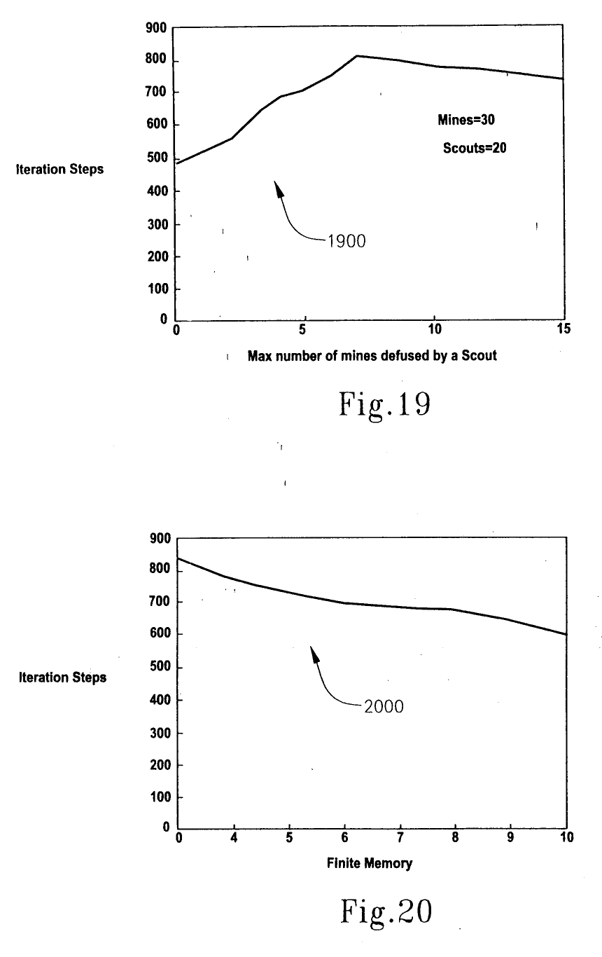

FIG. 19 plots, at 1900, the effect of finite lifetime for the scouts on the performance of the system. Lifetime of the scouts is evaluated by the number of mines they defuse, rather than the amount of time spent on the minefield. Although the amount of time spent diffusing may directly effect the battery life of the scouts in practical terms, the number of mines defused has a direct bearing, and a more profound effect, in determining the lifetime of the scout. This may be due to factors such as amount of resources present with the scout (explosives) to defuse the mines. In FIG. 19, it can be seen that, as the lifetime of the scout increases, the process becomes more efficient.

Finally, FIG. 20 plots, at 2000, the effect of finite memory on the performance of the system. The finite memory here points to the amount of recent mine locations that scout can retain at any point of time during the mine detection process. It can be seen that performance gradually improves as memory increases. This reflects the fact that incorporation of cognitive maps and cognitive memory is beneficial to the system in the long run.

At this point, reference is made again to the introductory FIGS. 1(a)-1(d) which, it may be recalled, depict a simulated time sequence for scouts foraging for mines over a 96×96 field. In FIG. 1(a) it may be seen that each of two scouts have located a mine and begun transmitting respective scent distributions signals 161 and 162, respectively. At this point, each scout will wait for a selected period of time for the requisite number of additional scouts to arrive, corresponding to a representative time it may take to diffuse the mines. Thus, in FIG. 1(b) it may be seen that representative mine 111 has been diffused (by virtue of it becoming shaded), while representative mine 132 has not been diffused. Since mine 132 was previously detected but not diffused, it corresponds to a situation in which a sufficient number of scouts did not arrive in the requisite period of time. Accordingly, the mine locating scout returned to the foraging state. At the time interval corresponding to FIG. 1(b), though, it may also be seen that three additional mines 134-135 have been located by virtue of the scent distributions 163-165 shown.

In FIG. 1(c) it may be seen that an additional two mines 134 and 136 have been diffused, while mine 135 remains undiffused since no other scouts have been attracted to the scent distribution 165. In addition, however, scouts have located a plurality of other mines and generated appropriate scent distributions 166-168 and, thus, await for additional scouts to arrive. In FIG. 1(d), numerous additional mines have been located as evidenced by the increasing number of scent distribution patterns 169-173. Moreover, it may be seen that additional scouts have been following the intensity trail associated with scent 166 so that the corresponding mine initially detected in FIG. 1(c) is soon to be diffused.

With an appreciation of the timing transitions which have been described with respect to FIGS. 1(a)-1(d), alone, the ordinarily skilled artisan can appreciate that the navigational routes and behaviors for the scouts will continue according to the principles discussed herein until eventually all mines have been detected and “diffused”. Accordingly, further explanation of this process need not be explained in detail to be readily understood.

From the foregoing, it can be appreciated that adaptability is an inherent characteristic of the mine detection system. When cognitive maps are brought into the picture this quality becomes more emphasized. Thus, it is believed that this model can provide the basis for a well-defined distributed control system. Advantageously, the model provides fairly simple agents with less sophistication accomplishing complex optimization problems, such as mine detection. The analysis results also emphasize how natural heuristic coupled with robust modeling can bring about a solution to a complex optimization problem.

What is claimed is:

1. A method of locating targets dispersed within a target field, comprising:
a. providing a plurality of like robotic scouts each designed to:
i. traverse the target field's terrain;
ii. detect existence of each target when in a vicinity thereof;
iii. transmit a target detection signal upon detecting existence of a target; and
iv. receive said target detection signal when transmitted by another one of said robotic scouts, and follow the signal's associated intensity gradient;
b. foraging the target field with said robotic scouts until each of the targets is located, whereby each of the robotic scouts forages according to a navigation scheme that entails:
i. stochastically navigating the terrain prior to receipt of said target detection signal;
ii. deterministically navigating the terrain following receipt of said target detection signal, whereby an intensity gradient of the received target detection signal is followed until detecting an existence of a selected target associated with the received target detection signal, whereupon the selected target is deemed located;
iii. remaining at the selected target until either:
1. a selected time duration elapses, or
2. a requisite number of other robotic scouts arrives at the selected target; and
iv. thereafter resuming foraging of the target field according to said navigation scheme.

2. The method according to claim 1 whereby the requisite number of other robotic scouts is three.

3. A method of emulating detection and diffusion of mines within a minefield, said method comprising:
a. simulating on a display device of a computer system a plurality of randomly dispersed mines within a boundary corresponding to a periphery of said minefield;
b. simulating on said display device a plurality of like robotic scouts each designed to:
i. traverse the minefield;
ii. detect existence of each mine when in a vicinity thereof;
iii. transmit a radially attenuating mine detection signal upon detecting existence of a mine; and
iv. receive said mine detection signal when transmitted by another one of said robotic scouts, and follow the signal's associated intensity gradient;
c. simulating foraging of the minefield with said robotic scouts until each of the mines is detected and defused, whereby each of the robotic scouts forages according to a navigation scheme that entails:
i. stochastically navigating the minefield prior to encountering said mine detection signal;
ii. deterministically navigating the minefield after encountering said mine detection signal, whereby an intensity gradient of the received mine detection signal is followed until detecting an existence of a selected mine associated with the received mine detection signal;
iii. remaining at the selected mine until either:
1. a selected time duration elapses, or
2. a requisite number of other robotic scouts arrives at the selected mine, corresponding to the selected mine being deemed defused; and
iv. thereafter resuming foraging of the minefield according to said navigation scheme.

4. The method according to claim 3 whereby the requisite number of other robotic scouts is three.
